(19) United States
(12) Patent Application Publication
(10) Pub. No.: US 2016/0253771 A1
(43) Pub. Date: Sep. 1, 2016

(54) Centralized Cemetery Data Management Listing System

(71) Applicant: CEMETERY360, INC., SACRAMENTO, CA (US)

(72) Inventor: James W. Pinocchio, SACRAMENTO, CA (US)

(21) Appl. No.: 15/055,590

(22) Filed: Feb. 27, 2016

Related U.S. Application Data
(60) Provisional application No. 62/126,054, filed on Feb. 27, 2015.

(51) Int. Cl. G06Q 50/18; G06Q 30/06

(52) U.S. Cl. CPC G06Q 50/186; G06Q 30/0643

(57) ABSTRACT

The inventive system provides a cemetery listing data management system where cemetery listing data and inventory information may be collected and assigned a unique searchable identifier value. The unique identifier value may be used to create a common standard nomenclature for cemetery databases that use disparate naming and identification conventions. With the unique identifier value, a user may search for cemetery listing data and other cemetery information without the needing prior knowledge of the individual cemetery's plot listing identification system.

### CROSS-REFERENCE TO RELATED APPLICATION

This application claims the benefit of U.S. Provisional Patent Application Ser. No. 62/126,054 entitled “Centralized Cemetery Data Management Listing System” filed on Feb. 27, 2015, the contents of which are incorporated by reference as if fully set forth herein.

### FIELD OF INVENTION

The present invention relates to a global cemetery data management system that provides a method for displaying cemetery plot listings using a unique global identification system.

### BACKGROUND OF INVENTION

In the cemetery industry, sales of plots requires careful record keeping of available, reserved, sold, and occupied plots. One aspect of this plot inventory record keeping requires individual cemeteries to identity each plot according to a cemetery specific naming convention. An example of a common identification system is a five field system where plot listings organized by garden, block, section, row and grave number. Cemeteries may also use systems that contains more than or less than five fields. Unfortunately, cemeteries' five file systems rarely use naming conventions that correspond one to one with how other cemeteries manage their plot inventories. Up until now there has never been any uniformity in plot identification that would be provide useful information to sales teams unfamiliar with a particular cemetery's naming conventions or to cemetery industry data vendors. The lack of a uniform plot identification convention can create issues when sales teams handling multiple cemeteries are trying to quickly identify and locate sold and unsold plots or when industry vendors attempt to manage and consolidate cemetery records. The lack of uniformity prevents organized global cemetery data management. The present invention seeks to solve this problem of the current insufficient means to organize and categorize cemeteries' plot inventory on a global scale.

### SUMMARY OF INVENTION

The inventive system provides a cemetery listing data management system where cemetery listing data and inventory information may be collected and assigned a unique searchable identifier value. The unique identifier value may be used to create a common standard nomenclature for cemetery databases that use disparate naming and identification conventions. With the unique identifier value, a user may search for cemetery listing data and other cemetery information without the needing prior knowledge of the individual cemetery's plot listing identification system.

In one embodiment the cemetery data management system is a computer-implemented method for displaying cemetery plot listing information to a remote network, that recieves cemetery plot listing information, by a processor, from a plurality of cemetery databases, wherein the cemetery plot listing information contains a value for at least one of cemetery plot location, cemetery plot coordinates, cemetery plot status, cemetery plot image, and cemetery text description, stores the cemetery plot listing information on a non-transitory computer-readable medium accessible over a computer network, assigns an identification value to each discrete cemetery plot listing, by the processor, such that each identification value is unique to all of the other cemetery plot listings stored on the non-transitory computer-readable medium, recalls a cemetery plot listing, by the processor, using the cemetery plot listing identification value, transmits the cemetery plot listing information over a network to a remote computing device that requested the cemetery plot listing information by using the cemetery plot listing identification value, and displays the recalled cemetery plot listing information on the remote computing device.

### BRIEF DESCRIPTION OF THE DRAWINGS

FIG. 1 depicts one embodiment of the cemetery plot inventory management system.

FIG. 2 depicts a flowchart of one embodiment of the system where cemetery listing data may be displayed.

FIG. 3 depicts one example of an interface for the inventive cemetery data and inventory management tool.

### DETAILED DESCRIPTION OF THE INVENTION

The following detailed description includes the best currently contemplated modes of carrying out exemplary embodiments of the invention. The description is not to be taken in a limiting sense, but is made merely for the purpose of illustrating the general principles of the invention, since the scope of the invention is best defined by the claims included herein.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more aspects of the described subject matter. It is to be appreciated, however, that such aspects can be practiced without these specific details. While certain components are shown in block diagram form to describe one or more aspects, it is to be understood that functionality performed by a single component can be performed by multiple components. Similarly, a single component can be configured to perform functionality described as being performed by multiple components.

The present invention provides a cemetery plot inventory management tool that improves on the ability to organize and communicate available and unavailable plot inventory within cemeteries. This management tool may be provided to internal cemetery staff and sales personal or it may be shared with outside sales teams and data management vendors hired or working in conjunction with a cemetery to market and sell cemetery plots and manage cemetery data.

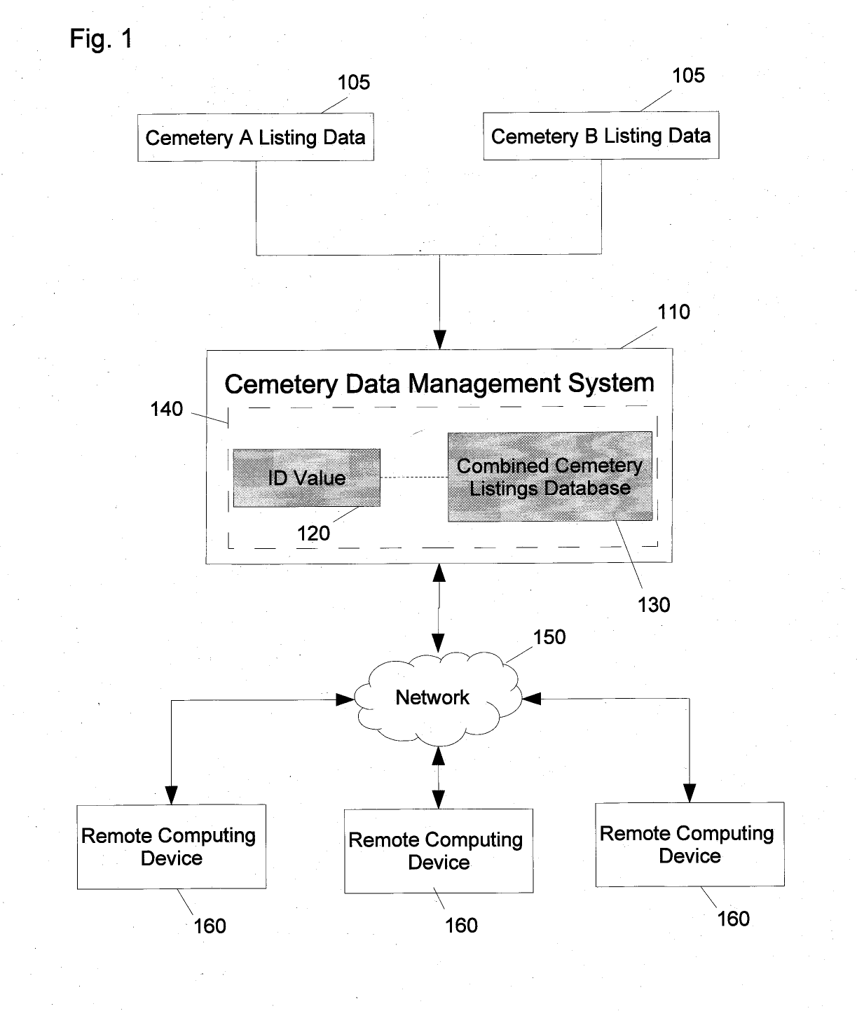

FIG. 1 depicts one embodiment of the cemetery plot inventory management system. In FIG. 1, cemetery listing data 105 may be collected from plurality of cemeteries and cemetery databases. The is no requirement that the cemetery listing data 105 be of a certain or standardized format for entry into the cemetery data management system 110. Indeed, it is expected that the cemetery listing data 105 may come disparate formatting standards used by different cemeteries. Once the cemetery listing data 105 is received by the cemetery data management system 110, a identification value 120 is assigned to the discrete set of data related to the particular cemetery listing 105 and is stored in a database 130 in a non-transitory computer-readable medium 140 that is accessible to the system network 110.

In one embodiment, the identification value 120 is a number that is unique across the system 110. The identification value 120 may be assigned using a non-repeating, incremental counter, that assigns a value of the next higher integer as the identification value 120. In this embodiment, the identification value 120 is unique on a global scale regardless of the source of the cemetery listing data 105, i.e. the assignment of the identification value 120 does not discriminate as to the cemetery source of the cemetery listing data 105. The identification value 120 may permanently linked to the plot listing 105 and will be associated with the listing throughout the system. Should the listing be deleted or undergo a status change, the unique identifier will remain assigned to the deleted listing within the database 130 and will not be reassigned to a new listing in the future.

The cemetery listing data may be recalled using the identification value 120, by sending a request to the cemetery data management system 110 across a computer network 150 The cemetery listing data may may then be retrieved from the combined cemetery listing database 130 and transmit to remote computing devices 160 for display. In this way, the remote use may access the cemetery listing data using only the identification value without needing to know or use the particular cemetery's naming conventions for organizing its data.

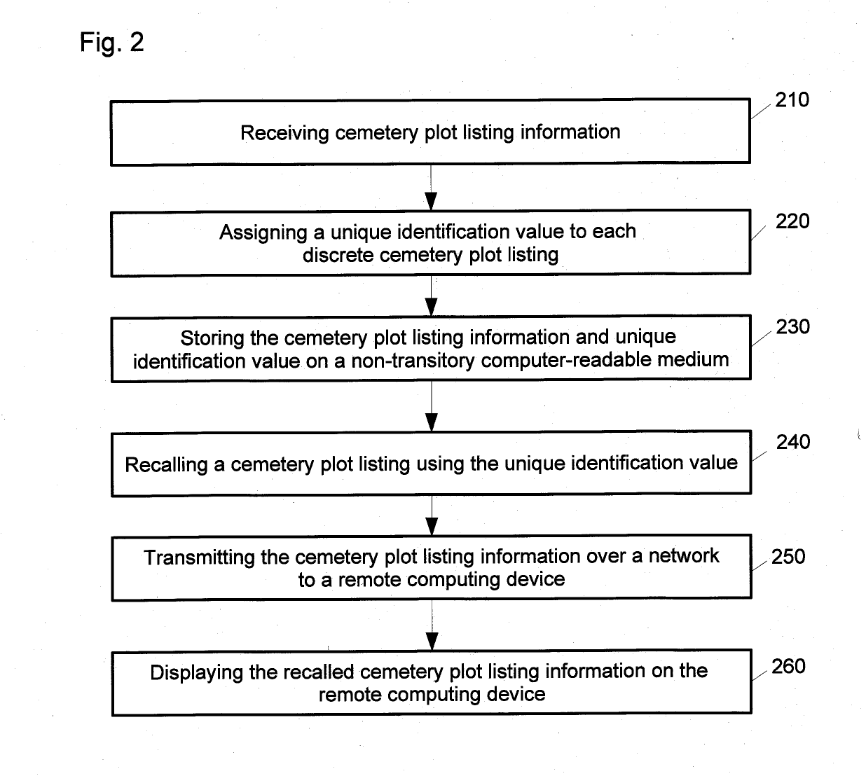

FIG. 2 depicts a flowchart of the one embodiment of the system where cemetery listing data 105 may be displayed. At step 210 the system may receive cemetery listing data 105 that may come from a plurality of cemetery database sources. This information may be received from either remote transmission of the cemetery listing data or it may be locally imputed in the cemetery data management system 110. Furthermore, the cemetery listing data 105 may be of a variety of different kinds of information that relate to an individual cemetery plot data and may contain without limitation information related to cemetery plot locations, cemetery plot coordinates, cemetery plot status, cemetery plot images and cemetery plot text descriptions.

At step 220, a unique identification value 120 is assigned to a discrete cemetery plot listing 105. The assignment of the identification value 120 may be done by assigning an integer of the next higher value of the previously assigned value starting at zero. It will be appreciated in the art that other means of assigning a unique, non-repeating value as an identifier may also be implemented without deferring from the disclosed inventive system.

Step 230 stores the unique identification value 120 along with its paired cemetery listing data 105 within a database 130 on a non-transitory computer-readable medium 140. The non-transitory computer-readable medium 140 is accessible to and may be locally or remotely connected to the cemetery data management system 110.

At step 240, the system 110 may be tasked to recalled the cemetery listing data 105 from the database 130 by using the identification value 120. This recall function may be performed using a microprocessor to search the storage medium 140 for the data the corresponds to the identification value 120.

Step 250 has the system 110 transmit the recalled cemetery list data 105 through a network 150 to a remote computing device 160. Step 260 has the recalled cemetery list data 105 displayed on the remote computing device 160. It will be recognized that the remote computer 160 may be a personal computer, smartphone, tablet computer or any other similar device capable of connecting to a local or remote computer network.

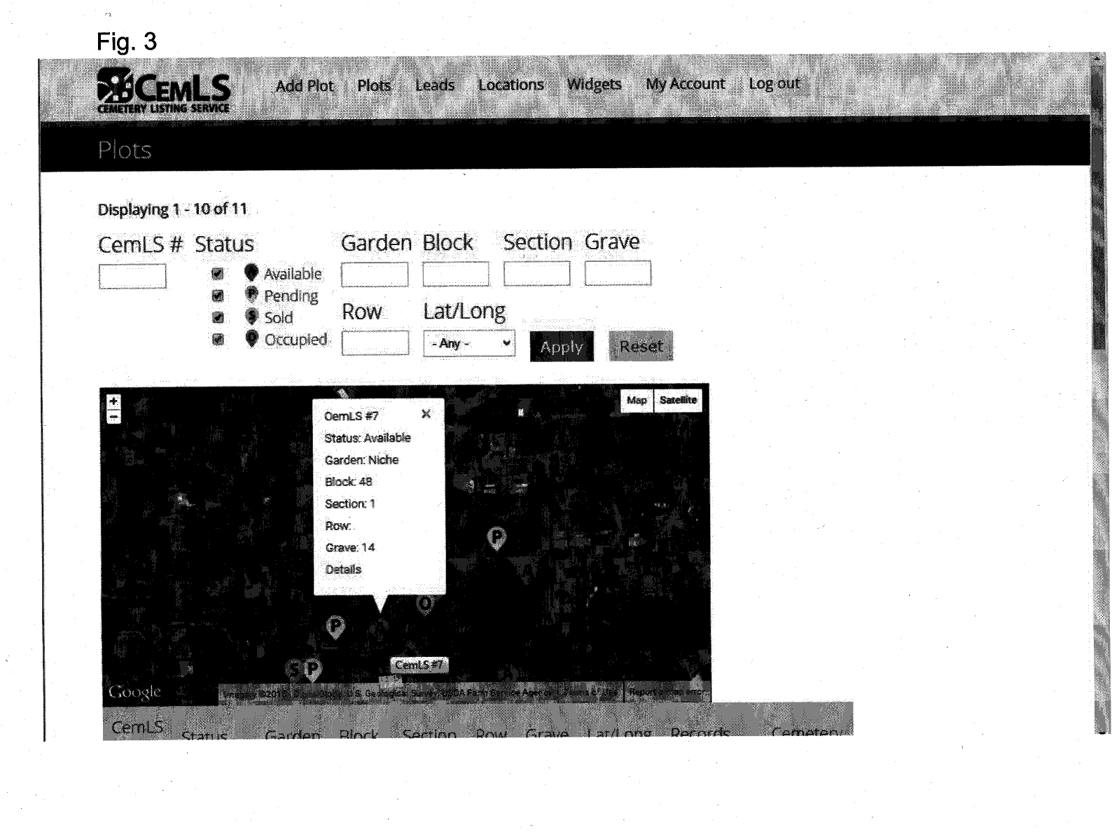

FIG. 3 depicts one example of an interface for the inventive cemetery data and inventory management tool. In one embodiment, the management tool may consist of a web-based interface that may be made available over the Internet or a private computer network. This web-based interface may be run from a computer server that is adapted to run the management tool software. The management tool software may consist of a interface having a menu with options to view a plots page, add plot page, records page, leads page, locations page, my account page and log out page.

Users of the interface may be categorized as cemetery administrators or group administrators who may control access to their cemetery's listing and inventory data accessible from the interface tool; inside group members who may individuals granted access by the cemetery group administrators to view and edit a cemetery group's listing and inventory data; outside group members who may be individuals granted restricted access by the cemetery/group administrator to view and edit with restricted ability a cemetery group's inventory data; and general members of the public who may search for cemetery plot availability. A website interface administrator may also exist to use the interface to provide maintenance and administrator interface controls over all other users of the interface.

A cemetery/group administrator may be the administrator over the information for its cemetery or group of cemeteries. The cemetery group administrator may define its group's name, and default cemetery map location. This default map location will display an aerial view of the group's cemetery within the map widget located on the plots page. The map widget may also appear on the other pages of the interface. The map may be generated using an available online map providing aerial views such as Google Maps.

A add plot page may consist of an interface that allows for the group administrator or group member with sufficient permission to add cemetery listing information into the group's database. The add plot page may have toggle buttons to select the assigned cemetery, status as available, reserved, sold or occupied. The add plot page may also allow the input to enter the new listing's garden, block, section, row, grave location, a text description, images, internal notes, and any leads on the plots. Additionally, the add plot page may have a map widget where the user can drop a pin that will associate a map coordinate, such as latitude and longitude, with the new listing. This map coordinate may also be tied to additional cemetery map data such as 360 degree cemetery mapping data. Such 360 degree cemetery mapping data may have corresponding latitude and longitude coordinates that may allow for 360 degree cemetery map imagery to be shown in connection with the new listing. There may also be a feature where the map widget will find the nearest available latitude and longitude coordinates for 360 degree cemetery map imagery.

In an alternative embodiment, the interface may be adapted to run on a mobile device such as smartphone or tablet computer. It is contemplated that the user adding a new plot listing may do so in the field, while standing at the physical site of the plot to be listed. The interface will, therefore, be adapted to use the mobile device's GPS and/or location tracking capabilities to use the location of the mobile device as the associated located with the listing. This may be done within the interface by selecting a “use my location” button within the add plots interface. The “use my location” button will gather the location tracking information from the mobile device and translate that information to longitude and latitude coordinate data and create a pin on the map widget at the coordinates. This assigned coordinate data with the new plot listing may also be tied to any 360 degree cemetery mapping data as well.

In one alternative embodiment, entry of data into a five fields identification system may generate a latitude and longitude coordinate. This may be accomplished by having the cemetery coordinate systems mapped with a GPS device and having the cemetery map coordinates cross-referenced to latitude and longitude coordinates. In this one embodiment, there may be 360 degree cemetery image map data that provides panoramic imagery of the cemetery at various map points. These map points may have assigned latitude and longitude coordinates. The interface may be able to use the five field data, a dropped pin in the map widget, or a given latitude and longitude and search for the nearest 360 degree cemetery image map data that corresponds to the search criteria. The result of this embodiment is that the user may enter the five field coordinate information and may generate a 360 degree cemetery map of that location, or the image of the nearest location to that coordinate. It is understood that this embodiment could be implemented with cemetery data consisting of less than or greater than five fields.

The add plot interface may also contain input fields for internal notes concerning the plot that are not to be shared with users not having the proper permission level. The add plot interface may also contain input to add sales leads which may consist of an individuals name and contact information and any relevant notes on the lead. In one embodiment, cemetery data management vendors may have the availability as outside group members to upload and download listing data to their own cemetery records database.

Once the desired amount of new plot listing information has been inputted into the add plot interface, the listing may be saved and a listing page will be generated by the interface. When the listing is generated, the interface will assign a unique identification value 120. The unique identification value 120 may be alphanumeric or it may numerals. The unique identification value 120 may be unique across all across a single cemetery group or the unique identification may be unique across all groups whose cemetery data is managed using the interface.

In one embodiment, the listing page contains the uploaded image(s) the user selected in the add plots interface. The listing page may also contain the unique identifier 120, a contact cemetery input box, listing of the block, section, row, and grave number (if available), description, 360 degree cemetery imagery, and aerial view map with location tag. If the user visiting the listing page has the necessary permission level, the user may have the ability to edit the plot listing by selecting the listing tab. When selecting the edit tab, the user may be able to alter and add substantially the same plot information as when using the add plot interface. The unique identification value 120 of the listing cannot be edited with edit listing interface.

The interface may contain a plots page that allows for the searching and viewing of all available listings within a cemetery group. The plots page may contain a search box for the unique identifier value 120. The user may also search by the status of available, reserved, sold or occupied. There may also be the searching of listings by garden, block, section, grave and row. The search of the listing may also be by whether the listing has an assigned latitude and longitude. When the search is applied to the cemetery listing database, a map widget will display an aerial map of the cemetery with coded tags to represent the available, reserved, sold and occupied listings. The user may then move their cursor over and click on the tag to reveal the listing's unique identifier, and all relevant listing data. The user may also be able to click the details link to take them to the plot listing page for that given unique identifier. Below the map widget the user may find a table displaying the results of their search criteria which may provide the relevant information and a link to each plot listing organized by the unique identification number.

In one embodiment the interface may have a lead tab that links to a leads page. The leads page may present a table of all sales leads entered for a cemetery group's listings. The table may include the unique identification value 120, the name of the lead, the date the lead was entered into the database, the user who entered the lead and the cemetery the listing belongs to. The user may click on the lead to be taken to a page giving the contact information of the lead and any notes entered describing the lead.

The interface may also have a locations tab that may take the user to the locations page. The locations page may have displayed the cemetery group's name and a table of the cemeteries within the the group, the length of time the user has been member of the group and the user roles within the group. The user roles is the permission level set for the user by the cemetery/group administrator. The user may select a cemetery to be linked to the cemetery's description page. The cemetery description page may include images of the cemetery, a description of the cemetery, address and contact information of the cemetery and an aerial map with a tag indicating the location of the cemetery. The information within the cemetery description page may be first set by the interface administrator when a new cemetery group is added to the database. The cemetery/group administrator or member the necessary permission level may have the ability to use an edit tab to make changes to all the information kept on the cemetery description page.

The cemetery description page may also have a tab entitled group. This group tab will take the user to a group member administration page. The group member page may allow the user to add members, manage members role within the group, view and edit permissions and view and edit group roles.

The add member interface allows the group administrator to designate any individual having an account with the interface, to be added as a member and given a predefined role. In one embodiment, the predefined roles may be an administrator, staff member (inside) and sales member (outside). These predefined roles contain preset permissions to access certain features within the interface. The add member interface also may contain a request message input where the administrator may send a message to the new member to alert them to their status and ability to use the interface.

The member management interface may allow the administrator to view all the members of the group and their various roles and status. The administrator will have the ability from the member management interface to modify a member's role, modify their status and remove members from the group.

The permissions management interface will allow the administrator to view the various permissions set for each predefined role and may allow the administrator to edit the permissions of the predefined roles. The various permissions are contained within a table and contain a comprehensive list of all the various functions within the interface that may be restricted by denying permission to a member. The roles management interface allow the administrator to view the types of available user roles and the permissions set for each role. In one embodiment the roles may set as non-member, member, administrator member, staff member (inside), and sales member (outside).

The interface may contain a widgets tab which may allow a user to embed a plot listing page within their own web page. It is contemplated that outside sales members may wish to advertise and market individual plot listings and by using the widget, they may display cemetery plot listings on their own web page. An industry vendor may also wish to use the widget to view or upload listing data unto their own cemetery database. In one embodiment, the outside sales member may embed the plot listing for a particular identification value 120, thereby displaying the availably of that plot listing 105.

The interface may contain an account information page that would allow for the administrator to edit its log-in data. The Administrator may be able to change its password, email address, upload its group page picture, allow users to contact the group administrator using a contact form, set the group's time zone and set the sub-user limit.

It is understood that a computer system may be used to implement aspects of the described subject matter and cemetery data management system 110. It is to be appreciated that aspects of the described subject matter can be implemented by various types of operating environments, computer networks, platforms, frameworks, computer architectures, and/or computing devices.

Implementations of computer system are described within the context of a system configured to perform various steps, methods, and/or functionality in accordance with aspects of the described subject matter. It is to be appreciated that a computer system can be implemented by one or more computing devices. Implementations of computer system can be described in the context of “computer-executable instructions” that are executed to perform various steps, methods, and/or functionality in accordance with aspects of the described subject matter.

In general, a computer system can include one or more processors and storage devices (e.g., memory and disk drives) as well as various input devices, output devices, communication interfaces, and/or other types of devices. A computer system also can include a combination of hardware and software. It can be appreciated that various types of computer-readable storage media can be part of a computer system. As used herein, the terms “computer-readable storage media” and “computer-readable storage medium” do not mean and unequivocally exclude a propagated signal, a modulated data signal, a carrier wave, or any other type of transitory computer-readable medium. In various implementations, a computer system can include a processor configured to execute computer-executable instructions and a computer-readable storage medium (e.g., memory and/or additional hardware storage) storing computer-executable instructions configured to perform various steps, methods, and/or functionality in accordance with aspects of the described subject matter.

Computer-executable instructions can be embodied and/or implemented in various ways such as by a computer program (e.g., client program and/or server program), a software application (e.g., client application and/or server application), software code, application code, source code, executable files, executable components, routines, application programming interfaces (APIs), functions, methods, objects, properties, data structures, data types, and/or the like. Computer-executable instructions can be stored on one or more computer-readable storage media and can be executed by one or more processors, computing devices, and/or computer systems to perform particular tasks or implement particular data types in accordance with aspects of the described subject matter.

System can implement and utilize one or more program modules. Generally, program modules include routines, programs, obj ects, components, data structures, etc., that perform particular tasks or implement particular abstract data types.

Computer system can be implemented as a distributed computing system or environment in which components are located on different computing devices that are connected to each other through network (e.g., wired and/or wireless) and/or other forms of direct and/or indirect connections. In such distributed computing systems or environments, tasks can be performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

It should be understood, of course, that the foregoing relates to exemplary embodiments of the invention and that modifications may be made without departing from the spirit and scope of the invention as set forth in the following claims.

I claim:

1. A computer-implemented method for displaying cemetery plot listing information to a remote network, the method comprising:
receiving cemetery plot listing information, by a processor, from a plurality of cemetery databases, wherein the cemetery plot listing information contains a value for at least one of cemetery plot location, cemetery plot coordinates, cemetery plot status, cemetery plot image, and cemetery text description,
storing the cemetery plot listing information on a non-transitory computer-readable medium accessible over a computer network,
assigning an identification value to each discrete cemetery plot listing, by the processor, such that each identification value is unique to all of the other cemetery plot listings stored on the non-transitory computer-readable medium,
recalling a cemetery plot listing, by the processor, using the cemetery plot listing identification value,
transmitting the cemetery plot listing information over a network to a remote computing device that requested the cemetery plot listing information by using the cemetery plot listing identification value, and
displaying the recalled cemetery plot listing information on the remote computing device.

2. The method for displaying cemetery plot listing information of claim 1, wherein the identification value is assigned to the cemetery plot listing when the cemetery plot listing information is received.

3. The method for displaying cemetery plot listing information of claim 1, wherein the identification value is a numeric value.

4. The method for displaying cemetery plot listing information of claim 3, wherein the identification value is assigned by an incremental counter that assigns the next higher integer from the previously assigned identification value.

5. The method for displaying cemetery plot listing information of claim 1, wherein once an identification value has been assigned, the identification value cannot be reassigned.

6. The method for displaying cemetery plot listing information of claim 1, wherein the cemetery plot location contains information related to at least one of garden, block, section, row, lot, grave location, and plot location.

7. The method for displaying cemetery plot listing information of claim 1, wherein the cemetery plot coordinates contain latitude and longitude coordinates.

8. The method for displaying cemetery plot listing information of claim 1, wherein the cemetery plot status is at least one of available, reserved, sold, and occupied.

9. The method for displaying cemetery plot listing information of claim 1, wherein the cemetery plot image contains at least one of two-dimensional cemetery image data and three-hundred and sixty degree cemetery image data.

10. The method for displaying cemetery plot listing information of claim 1, wherein the remote computing device may be mobile computing device.

11. The method for displaying cemetery plot listing information of claim 1, wherein the cemetery plot listing information is received over the Internet.
